(19) United States
(12) Patent Application Publication
(10) Pub. No.: US 2024/0249555 A1
(43) Pub. Date: Jul. 25, 2024

(54) METHOD FOR DETECTING HUMAN BEHAVIOR, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Song Xue, Beijing (CN); Yuan Feng, Beijing (CN); Ying Xin, Beijing (CN); Bin Zhang, Beijing (CN); Chao Li, Beijing (CN); Xiaodi Wang, Beijing (CN); Yunhao Wang, Beijing (CN); Yi Gu, Beijing (CN); Xiang Long, Beijing (CN); Honghui Zheng, Beijing (CN); Yan Peng, Beijing (CN); Zhuang Jia, Beijing (CN); Shumin Han, Beijing (CN)

(73) Assignee: BEIJING BAIDU NETCOM SCIENCE TECHNOLOGY CO., LTD., Beijing (CN)

(21) Appl. No.: 17/995,743

(22) PCT Filed: Apr. 20, 2022
(86) PCT No.: PCT/CN2022/088033

§ 371 Date: Oct. 7, 2022

(30) Foreign Application Priority Data
Apr. 27, 2021 (CN) 202110462200.9

(51) Int. Cl. G06V 40/20; G06T 7/73; G06V 10/25

(52) U.S. Cl. CPC G06V 40/20; G06T 7/73; G06V 10/25; G06T 2207/30196

(57) ABSTRACT

A method for detecting a human behavior includes: obtaining an image to be detected; obtaining a plurality of key points and a plurality of pieces of position information respectively corresponding to the plurality of key points by key-point recognition on the image to be detected; grouping the plurality of key points based on the plurality of pieces of position information to obtain a plurality of key-point groups, the plurality of key-point groups at least including a part of the plurality of key points; and determining a target human behavior based on key points in the plurality of key-point groups.

### CROSS-REFERENCE TO RELATED APPLICATION

This application is the national phase of International Application No. PCT/CN2022/088033, filed on Apr. 20, 2022, which is based upon and claims a priority to Chinese Patent Application No. 202110462200.9, filed with China National Intellectual Property Administration on Apr. 27, 2021, the entire content of which is incorporated herein by reference.

### FIELD

The disclosure relates to the field of artificial intelligence (AI) technologies and more particularly to the field of computer vision, deep learning and the like technologies, applicable to an intelligent cloud and a security patrol scene, and further relates to a method for detecting a human behavior, an electronic device, and a storage medium.

### BACKGROUND

AI is a subject that studies computers to simulate certain thinking processes and intelligent behaviors (such as learning, reasoning, thinking and planning) of human, which has both hardware-level technologies and software-level technologies. AI hardware technology generally includes technologies such as sensors, dedicated AI chips, cloud computing, distributed storage, and big data processing. AI software technology generally includes computer vision technology, speech recognition technology, natural language processing technology, machine learning, deep learning, big data processing technology, knowledge map technology and other aspects.

In the related art, a method for detecting a human behavior in a security patrol scene has a poor real-time performance and a poor detection effect on the human behavior such as a human violation behavior or personnel safety clothing.

### SUMMARY

According to a first aspect, a method for detecting a human behavior is provided. The method includes: obtaining an image to be detected; obtaining a plurality of key points and a plurality of pieces of position information respectively corresponding to the plurality of key points by key-point recognition on the image to be detected; grouping the plurality of key points based on the plurality of pieces of position information to obtain a plurality of key-point groups, the plurality of key-point groups at least including a part of the plurality of key points; and determining a target human behavior based on key points in the plurality of key-point groups.

According to a second aspect, an electronic device is provided. The electronic device includes: at least one processor and a memory. The memory is communicatively coupled to the at least one processor. The memory is configured to store instructions executable by the at least one processor. The at least one processor is configured to implement the method for detecting the human behavior according to the above embodiments of the disclosure when the instructions are executed by the at least one processor.

According to a third aspect, a non-transitory computer-readable storage medium having computer instructions stored thereon is provided. The computer instructions are configured to cause a computer to execute the method for detecting the human behavior according to the above embodiments of the disclosure.

It should be understood that, content described in the Summary is not intended to identify key or important features of embodiments of the disclosure, nor is it intended to limit the scope of the disclosure. Other features of the disclosure will become apparent from the following description.

### BRIEF DESCRIPTION OF THE DRAWINGS

The accompanying drawings are used for better understanding the solution and do not constitute a limitation of the disclosure.

FIG. 1 is a flow chart according to a first embodiment of the disclosure.

FIG. 2 is a schematic diagram illustrating an image to be detected in embodiments of the disclosure.

FIG. 3 is a schematic diagram illustrating a heat map of key points in embodiments of the disclosure.

FIG. 4 is a schematic diagram illustrating another image to be detected in embodiments of the disclosure.

FIG. 5 is a flow chart according to a second embodiment of the disclosure.

FIG. 6 is a flow chart according to a third embodiment of the disclosure.

FIG. 7 is a block diagram illustrating detection boxes in embodiments of the disclosure.

FIG. 8 is a block diagram illustrating an apparatus for detecting a human behavior in embodiments of the disclosure.

FIG. 9 is a block diagram according to a fourth embodiment of the disclosure.

FIG. 10 is a block diagram according to a fifth embodiment of the disclosure.

FIG. 11 is a block diagram illustrating an electronic device for implementing a method for detecting a human behavior according to embodiments of the disclosure.

### DETAILED DESCRIPTION

Description will be made below to embodiments of the disclosure with reference to accompanying drawings, which includes various details of embodiments of the disclosure to facilitate understanding and should be regarded as merely examples. Therefore, it should be recognized by the skilled in the art that various changes and modifications may be made to the embodiments described herein without departing from the scope and spirit of the disclosure. Meanwhile, for clarity and conciseness, descriptions for well-known functions and structures are omitted in the following description.

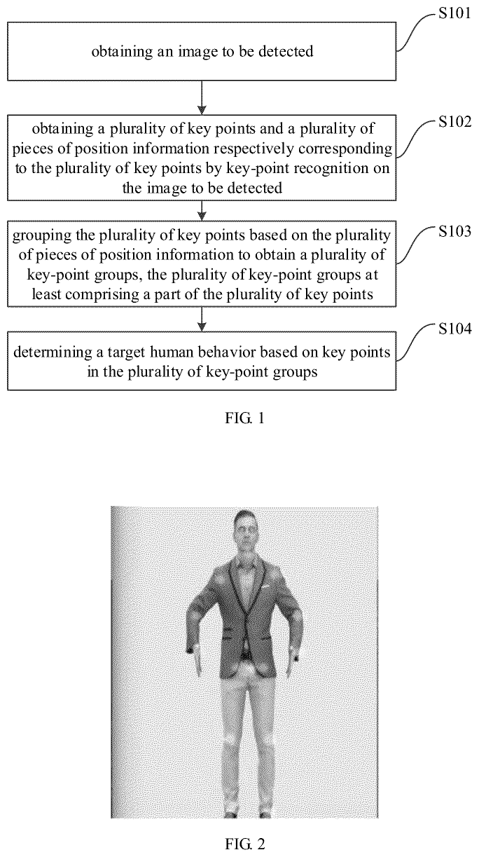

FIG. 1 is a flow chart according to a first embodiment of the disclosure.

It should be noted that, an executive subject of a method for detecting a human behavior according to embodiments of the disclosure is an apparatus for detecting a human behavior. The apparatus may be implemented in a software and/or hardware way. The apparatus may be configured in an electronic device. The electronic device may include, but not limited to, a terminal, a server, etc.

Embodiments of the disclosure relate to the field of AI technologies and more particularly to the field of computer vision, deep learning and the like technologies, which may be applicable to an intelligent cloud and a security patrol scene, to improve an accuracy and an efficiency of detection and recognition for detecting and recognizing the human behavior in the security patrol scene, effectively satisfying real-time requirements of detection and recognition in the security patrol scene.

Artificial intelligence is abbreviated as AI. AI is a new technological science that researches and develops theories, methods, technologies and application systems for simulating, extending and expanding human intelligence.

DL (deep learning) is to learn inherent laws and representation hierarchies of sample data. Information obtained during the DL is helpful to interpretation of data such as texts, images and sounds. An ultimate goal of the DL is to enable machines to have an ability to analyze and learn like human beings, and to recognize data such as text, images and sounds.

Computer vision refers to performing machine vision, such as recognition, tracking and measurement, on a target by using cameras and computers instead of human eyes, and further performing image processing, to enable the target through computer processing to become an image more suitable for human eyes to observe or transmitted to an instrument for detection.

The safety patrol scene refers to an inspection scene that needs to perform safety helmet wearing detection, smoking detection and calling detection on staff in a safety operation production environment in a factory. It should be noted that, human attribute detection on the staff in this scene is to ensure normal safety operation.

As illustrated in FIG. 1, the method for detecting the human behavior includes the following.

At block S101, an image to be detected is obtained.

The image for detecting the human behavior may be called as the image to be detected. There may be one or more images to be detected. The image to be detected may be, such as, a picture or an image corresponding to a video frame in a video clip. The image to be detected may also be a two-dimensional image or a three-dimensional image, which is not limited herein.

When the image to be detected is obtained, a real-time video stream of each surveillance camera in the inspection scene may be read by invoking an OpenCV module of a visual processing algorithm of a computer programming language such as python, and each frame of the real-time video stream is processed as the image to be detected. There is no limitation on the image.

In other words, the image to be detected in embodiments of the disclosure may be obtained by parsing the real-time video stream. That is, the apparatus for detecting the human behavior may be configured in advance with integrating the OpenCV module of the visual processing algorithm, such that the method for detecting the human behavior may interact with collection module(s) for real-time video stream(s) in real time to parse the real-time video stream to obtain the image to be detected.

At block S102, a plurality of key points and a plurality of pieces of position information respectively corresponding to the plurality of key points are obtained by key-point recognition on the image to be detected.

In obtaining the image to be detected, the key-point recognition may be performed on the image to be detected to obtain the plurality of key points and the plurality of pieces of position information respectively corresponding to the plurality of key points. The key points may be key human joint points which may characterize human behavior postures. The key joint points may be, such as, a head, a left shoulder, a right shoulder, a left elbow, a right elbow, a left wrist, a right wrist, a left arm, a right arm, a left knee, a right knee, a left ankle, a right ankle, a neck, and the like.

Accordingly, the position information may be configured to describe a whole position of the above key joint point with respect to the image to be detected. The position information may be, such as, position coordinates of a center point of the head with respect to the image to be detected, which is not limited.

In embodiments of the disclosure, the plurality of key points in the image to be detected and the plurality of pieces of position information corresponding to the plurality of key points may also be represented in the form of a heat map, which is illustrated below.

In some embodiments, when the key-point recognition is performed on the image to be detected, a deep high-resolution representation learning model for visual recognition (HRNet) may be employed, which is not limited. In other words, a backbone network of the HRNet model may be employed to extract characteristics of the image to be detected, and then a scale-aware high-resolution heat map may be generated based on the characteristics extracted and in conjunction with a resolution heat-map aggregation strategy in the related art.

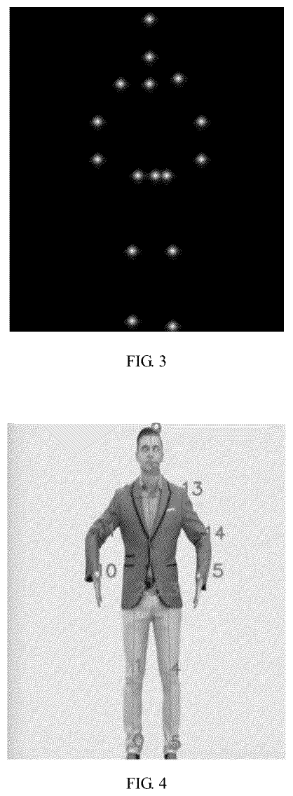

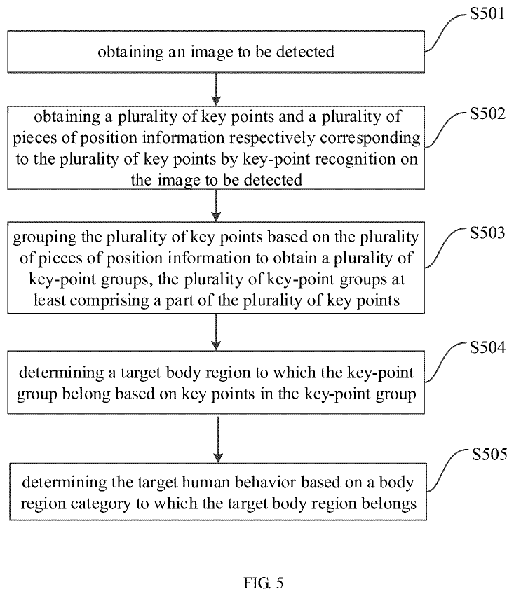

As illustrated in FIG. 2, FIG. 3 and FIG. 4, FIG. 2 is a schematic diagram illustrating an image to be detected in embodiments of the disclosure. FIG. 3 is a schematic diagram illustrating a heat map of key points in embodiments of the disclosure. The plurality of key points and position information corresponding to the plurality of key points are illustrated correspondingly in FIG. 2. In a detailed implementation process, serial number marking may be performed on the plurality of key points in FIG. 2 for distinguishing. FIG. 4 is a schematic diagram illustrating another image to be detected in embodiments of the disclosure. In FIG. 4, key points of the image to be detected are marked with serial numbers.

In some embodiments, any possible recognition manner may also be employed to recognize the key points and the position information of the key points in the image to be detected, which is not limited.

At block 103, the plurality of key points are grouped based on the plurality of pieces of position information to obtain a plurality of key-point groups. The plurality of key-point groups at least include a part of the plurality of key points.

After the key-point recognition is performed on the image to be detected to obtain the plurality of key points and the plurality of pieces of position information corresponding to the plurality of key points, the plurality of key points may be grouped based on the plurality of pieces of position information to obtain the plurality of key-point groups. Subsequently, different manners for recognizing the human behavior may be triggered based on different key-point groups.

In other words, with embodiments of the disclosure, it is supported that the plurality of key points are firstly grouped based on the plurality of pieces of position information by employing a certain strategy. There are same or similar aggregation characteristics (the aggregation characteristics may be configured to mark a corresponding posture) among the plurality of key points in different key-point groups. Therefore, in subsequent recognition on the human behavior, the aggregation characteristics among the plurality of key points in the key-point group may assist in human behavior detection, thereby effectively guaranteeing the accuracy of the human behavior detection.

In embodiments of the disclosure, the key points recognized from the image to be detected may be, such as, a head, a left shoulder, a right shoulder, a left elbow, a right elbow, a left wrist, a right wrist, a left arm, a right arm, a left knee, a right knee, a left ankle, a right ankle, a neck, and the like. When the plurality of key points are grouped based on the plurality of pieces of position information, a part of key points belonging to a same limb may be at least divided into a same key-point group, such that the aggregation characteristics of the part of key points belonging to the same limb in the key-point group may be employed to mark whether a human is in a standing posture or a squatting posture, which is not limited.

For another example, key points not belonging to a certain limb may also be separately divided into a key-point group. For example, the head and the neck do not actually belong to a same limb, key points of the head may be divided into a key-point group A and key points of the neck may be divided into a key-point group B, which is not limited.

In some embodiments, any possible dividing manner may also be employed to group the plurality of key points, which is not limited.

In embodiments of the disclosure, in order to ensure that the key points divided may effectively assist subsequently human behavior detection, the key points may also be connected from bottom to top by using a greedy analytic algorithm based on body structural characteristics to visually output a calculation result. As illustrated in FIG. 4, the key points are grouped based on the calculation result outputted visually and a connection condition. Connecting the plurality of key points from bottom to top by using the greedy analytic algorithm based on the body structural characteristics may refer to following connection rules.

Assuming that the key points are joint points corresponding to the human body, the connection rule based on the body structural characteristics is that a same joint in a same type of joint points is not simultaneously connected with two joints in another type of joint points.

At block S104, a target human behavior is determined based on key points in the plurality of key-point groups.

After the plurality of key points are grouped based on the plurality of pieces of position information to obtain the plurality of key-point groups, the target human behavior may be determined based on the key points in the plurality of key-point groups. In other words, in embodiments of the disclosure, the plurality of key-point groups recognized from the image to be detected assist the determination of the target human behavior, thereby implementing that the aggregation characteristics among the key points in the plurality of key-point groups assist in the human behavior detection, and effectively guaranteeing the accuracy of the human behavior detection.

With embodiments of the disclosure, the image to be detected is obtained. The plurality of key points and the plurality of pieces of position information respectively corresponding to the plurality of key points are obtained by the key-point recognition on the image to be detected. The plurality of key points are grouped based on the plurality of pieces of position information to obtain the plurality of key-point groups. The plurality of key-point groups at least include the part of the plurality of key points. The target human behavior is determined based on the key points in the plurality of key-point groups. In this way, the accuracy and the efficiency of detection and recognition for the human behavior in the security patrol scene may be improved, thereby effectively satisfying the real-time requirements of detection and recognition in the security patrol scene.

FIG. 5 is a flow chart according to a second embodiment of the disclosure.

As illustrated in FIG. 5, a method for detecting a human behavior includes the following.

At block S501, an image to be detected is obtained.

At block S502, a plurality of key points and a plurality of pieces of position information respectively corresponding to the plurality of key points are obtained by key-point recognition on the image to be detected.

At block 503, the plurality of key points are grouped based on the plurality of pieces of position information to obtain a plurality of key-point groups. The plurality of key-point groups at least include a part of the plurality of key points.

Description for the actions at blocks S501-503 may refer to the above embodiments, which is not elaborated herein.

At block 504, a target body region to which the key-point group belong is determined based on key points in the key-point group.

At block 505, the target human behavior is determined based on a body region category to which the target body region belongs.

A body region may be, such as, a head region, a neck region, a left upper limb region, a right upper limb region, a left lower limb region, a right lower limb region, a body region or the like of a human body, which is not limited.

The target body region may be any of the above body regions. In embodiments of the disclosure, after the key-point group is obtained by dividing the key points, a body region to which the key-point group possibly belong may be determined based on the part of key points included in the key-point group and position information corresponding to each key point, and then the body region may be taken as the target body region.

The body region category may be, such as, a head category, a neck category, a left upper limb category, a right upper limb category, a left lower limb category, a right lower limb category, a body category or the like, which is not limited.

The body region category corresponding to the target body region may be called as the body region category to which the target body region belongs. The body region category may be employed to subsequently determine an appropriate manner for detecting the human behavior.

With embodiments of the disclosure, the image to be detected is obtained. The plurality of key points and the plurality of pieces of position information respectively corresponding to the plurality of key points are obtained by the key-point recognition on the image to be detected. The plurality of key points are grouped based on the plurality of pieces of position information to obtain the plurality of key-point groups. The plurality of key-point groups at least include a part of the plurality of key points. The target human behavior is determined based on the key points in the plurality of key-point groups. The accuracy and efficiency of detection and recognition for the human behavior in the security patrol scene may be improved, thereby effectively satisfying the real-time requirements of detection and recognition in the security patrol scene. With embodiments of the disclosure, it may be supported that, the key points recognized are divided in conjunction with the body structural characteristics and the position information of the key points, so as to assist in subsequent selection of a suitable manner for detecting the human behavior, and enable the method for detecting the human behavior to flexibly adapt to different human regions, thereby implementing a refined human behavior detection.

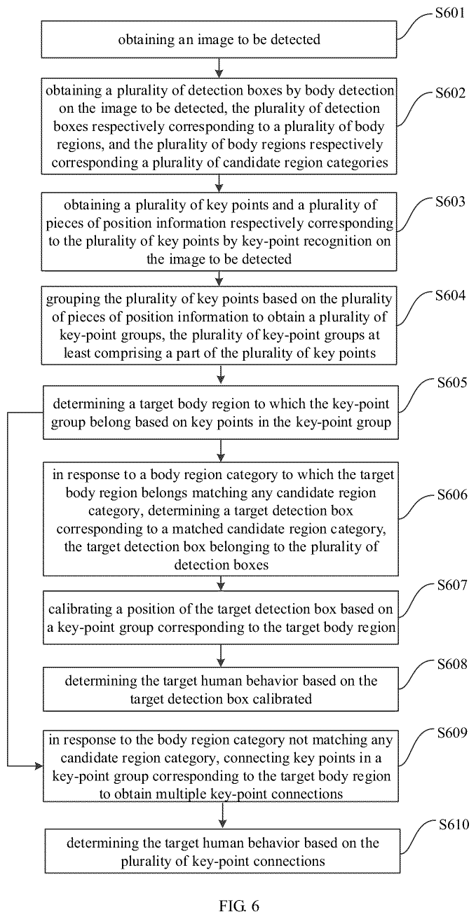

FIG. 6 is a flow chart according to a third embodiment of the disclosure.

As illustrated in FIG. 6, a method for detecting a human behavior includes the following.

At block S601, an image to be detected is obtained.

Description for the actions at block S601 may refer to the above embodiments, which is not elaborated herein.

At block S602, a plurality of detection boxes are obtained by body detection on the image to be detected. The plurality of detection boxes respectively correspond to a plurality of body regions. The plurality of body regions respectively correspond a plurality of candidate region categories.

After the image to be detected is obtained, the body detection may be performed on the image to be detected to obtain the plurality of detection boxes. The plurality of detection boxes respectively include the plurality of body regions. The plurality of body regions respectively correspond the plurality of candidate region categories.

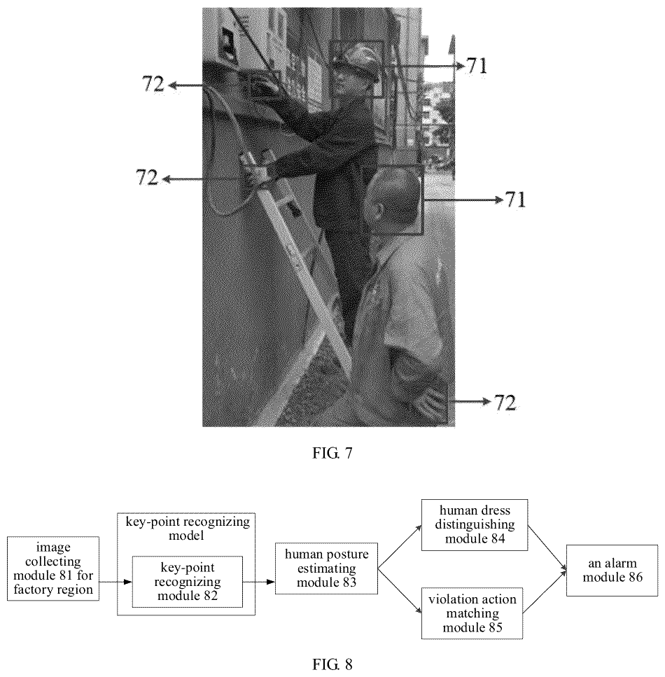

As illustrated in FIG. 7, FIG. 7 is a block diagram illustrating detection boxes in embodiments of the disclosure. A detection box 71 includes a head region, and a detection box 72 includes a hand region, which is not limited.

When the body detection is performed on the image to be detected, any possible manner for target detection may be employed to locate the plurality of detection boxes from the image to be detected, which is not limited herein.

Referring to the above description, after the body region included in each detection box is determined, the body region category marked for the body region may be directly taken as the candidate region category.

Assuming that the detection box 71 includes the head region and the detection box 72 includes the hand region, the candidate region category of the detection box 71 may be the head category, and the candidate region category of the detection box 72 may be the hand category, which is not limited.

In embodiments of the disclosure, the candidate region category may be specifically summarized as a non-limb category, i.e., a head category, a hand category, a neck category, or a body category. Correspondingly, a limb category may be, such as, a left upper limb category, a right upper limb category, a left lower limb category, or a right lower limb category, which is not limited.

After the body detection is performed on the image to obtain the plurality of detection boxes, the plurality of detection boxes may be configured as reference boxes for detecting the human behavior, thereby supporting subsequent human behavior detection in conjunction with the body region of the non-limb category in embodiments of the disclosure, effectively improving comprehensiveness of reference content of the human behavior detection, and enabling the detected human behavior more accurate.

At block S603, a plurality of key points and a plurality of pieces of position information respectively corresponding to the plurality of key points are obtained by key-point recognition on the image to be detected.

At block S604, the plurality of key points are grouped based on the plurality of pieces of position information to obtain a plurality of key-point groups. The plurality of key-point groups at least include a part of the plurality of key points.

At block S605, a target body region to which the key-point group belong is determined based on key points in the key-point group.

Description for the actions at blocks S603-S605 may refer to the above embodiments, which is not elaborated herein.

At block S606, in response to a body region category to which the target body region belongs matching any candidate region category, a target detection box corresponding to a matched candidate region category is determined. The target detection box belongs to the plurality of detection boxes.

It is assumed that the candidate region category may be specifically classified into the non-limb category, i.e. the head category, the hand category, the neck category, or the body category. In response to a fact that the body region category to which the target body region belongs matches any candidate region category, it indicates that the body region category to which the target body region belongs is the non-limb category, and then the corresponding detection box (the detection box corresponding to the body region category to which the target body region belongs may be called the target detection box) may be detected in advance based on the body region of the non-limb category.

In embodiments of the disclosure, it may be supported that the detection box corresponding to the non-limb category obtained in advance is calibrated. For details, see subsequent embodiments.

At block S607, a position of the target detection box is calibrated based on a key-point group corresponding to the target body region.

The body region category to which the target body region belongs matches any candidate region category (non-limb category), and the target detection box corresponding to the matched candidate region category is determined. Then the position of the target detection box is calibrated based on the key-point group corresponding to the target body region, such that the position of the calibrated target detection box matches the target body region more accurately, and the target human behavior determined based on the calibrated target detection box may be more in line with an actual situation, thereby ensuring the detection accuracy.

When the position of the target detection box is calibrated based on the key-point group corresponding to the target body region, a target center position may be determined based on position information of each key point in the key-point group, and then a center position of the target detection box may be adjusted to the target center position, which is not limited.

In some embodiments, the position information of each key point in the key-point group may be input into a calibration model trained in advance to obtain a target position outputted by the calibration model, and then the center position of the target detection box may be adjusted to the target position, which is not limited.

At block S608, a target human behavior is determined based on the target detection box calibrated.

After the position of the target detection box is calibrated based on the key-point group corresponding to the target body region, the target human behavior may be directly determined based on the target detection box calibrated.

The target human behavior determined may be, such as, smoking or not, wearing work clothes or not, wearing a safety helmet or not, or making a phone call or not, which is not limited.

For example, characteristic recognition may be performed on a local image defined by the target detection box calibrated, and the target human behavior may be determined based on characteristics recognized from the local image, which is not limited.

At block S609, in response to the body region category to which the target body region belongs not matching any candidate region category, key points in a key-point group corresponding to the target body region are connected to obtain a plurality of key-point connections.

In some embodiments, in response to a fact that the body region category to which the target body region belongs does not match the candidate region category, it indicates that the body region category to which the target body region belongs is the limb category, i.e., the left upper limb category, the right upper limb category, the left lower limb category, or the right lower limb category, the key points corresponding to the key-point group may be connected to obtain the plurality of key-point connections.

In some embodiments, a way for connecting the key points in the key-point group to obtain the plurality of key-point connections may be connecting the key points in the key-point group from bottom to top by using a greedy analytic algorithm based on body structural characteristics.

Assuming that the key points are joint points corresponding to a human body, a connection rule based on the body structural characteristics is that a same joint in the same type of joint points is not simultaneously connected with two joints in another type of joint points.

In embodiments of the disclosure, global context information may be fully encoded in an expression mode of at least connecting a part of key points and in conjunction with the greedy analytic algorithm, thereby effectively shorten a period of the human behavior detection, and simultaneously achieving a better expression accuracy.

At block S610, the target human behavior is determined based on the plurality of key-point connections.

When the body region category to which the target body region belongs does not match the candidate region category, the key points in the key-point group are connected to obtain the plurality of key-point connections, and then the target human behavior may be determined based on the plurality of key-point connections.

For example, a body posture may be determined based on each key-point connection, and then the body posture may be compared with a preset correspondence. The preset correspondence may include: candidate body postures and a candidate human behavior corresponding to each candidate body posture. A candidate body posture matching with the body posture is determined, and a candidate human behavior corresponding to the candidate body posture matched is taken as the target human behavior, which is not limited.

Alternatively, the body posture may be determined in any possible way and in conjunction with the plurality of key-point connections. For example, it is judged whether the human body falls or not, or whether the left upper limb or the right upper limb is close to a mouth, an ear or the like of the human body, based on an inclination angle of the key-point connection. When it is determined that the left upper limb or the right upper limb is close to the mouth of the human body, it may be determined that there may be a smoking action, and then it is verified whether there is the smoking action in conjunction with characteristics of a local image of the head region. When it is determined that the left upper limb or the right upper limb is close to the ear of the human body, it may be determined that there may be a phone calling action, and then it is verified whether there is the phone calling action in conjunction with characteristics of a local image of the ear region, which is not limited.

Therefore, in embodiments of the disclosure, when the body region category to which the target body region belongs does not match the candidate region category, the key points in the key-point group are connected to obtain the plurality of key-point connections, and then the target human behavior may be determined based on the plurality of key-point connections, thereby providing a flexible way for determining the human behavior, and enabling the method for detecting the human behavior to have a better practicability. In this way, the accuracy and timeliness of the human behavior detection are greatly improved, human resources consumed by the human behavior detection are effectively reduced, and safe production and operation of a factory region are ensured.

After the target human behavior is detected and recognized, an apparatus for detecting a human behavior may send an alarm instruction to an intelligent device. Based on the alarm instruction, a monitoring personnel may be informed that there may be an illegal human behavior.

As illustrated in FIG. 8, FIG. 8 is a block diagram illustrating an apparatus for detecting a human behavior in embodiments of the disclosure, which includes an image collecting module 81 for a factory region, and a key-point recognizing module 82. The key-point recognizing module 82 may be internally provided in a key-point recognition model for recognizing a plurality of key points and position information corresponding to the plurality of key points in the image to be detected. The apparatus also includes a human posture estimating module 83, a human dress distinguishing module 84, a violation action matching module 85, and an alarm module 86, which are configured to support each action in the above embodiments of the method for detecting the human behavior, without limitation.

In embodiments of the disclosure, after body detection is performed on the image to be detected to obtain the plurality of detection boxes, the plurality of detection boxes may be taken as reference boxes for detecting the human behavior, thereby supporting subsequent detection on the human behavior in conjunction with the body region of the non-limb category in embodiments of the disclosure, and effectively improving comprehensiveness of reference contents of detecting the human behavior, such that the human behavior detected is more accurate. When a body region category to which a target body region belongs matches any candidate region category (non-limb category), a target detection box corresponding to a matched candidate region category is determined, and then a position of the target detection box is calibrated based on a key-point group corresponding to the target body region, such that a position of the calibrated target detection box matches the target body region more accurately, and the target human behavior determined based on the target detection box calibrated may be more in line with an actual situation, thereby ensuring detection accuracy. Global context information may be fully encoded in an expression mode of at least connecting a part of key points and in conjunction with a greedy analytic algorithm, thereby effectively shorten a period of the human behavior detection, and simultaneously achieving a better expression accuracy. When the body region category to which the target body region belongs does not match the candidate region category, key points in the key-point group corresponding to the target body region are connected to obtain a plurality of key-point connections, and then the target human behavior may be determined based on the plurality of key-point connections, which provides a flexible way to determine the human behavior, such that the method for detecting the human behavior has a better practicability. While the accuracy and timeliness of human behavior detection are greatly improved, human resources consumed by the human behavior detection are effectively reduced, and the safe production and operation of the factory are ensured.

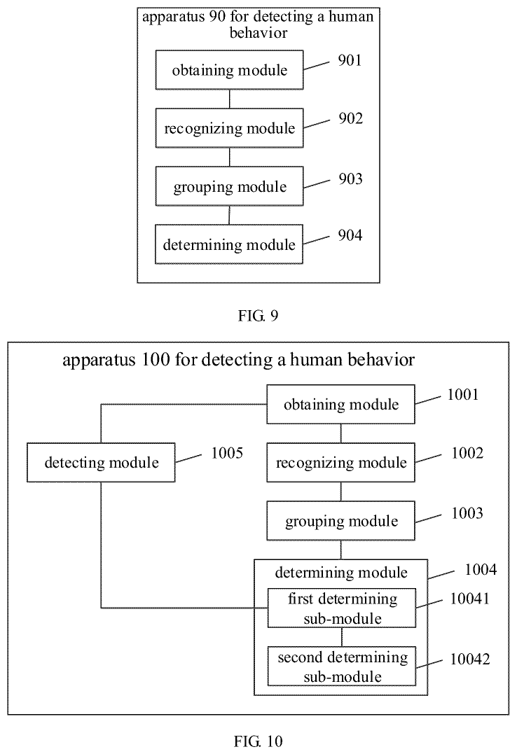

FIG. 9 is a block diagram according to a fourth embodiment of the disclosure.

As illustrated in FIG. 9, an apparatus 90 for detecting a human behavior includes: an obtaining module 901, configured to obtain an image to be detected; a recognizing module 902, configured to obtain a plurality of key points and a plurality of pieces of position information respectively corresponding to the plurality of key points by key-point recognition on the image; a grouping module 903, configured to group the plurality of key points based on the plurality of pieces of position information to obtain a plurality of key-point groups, the plurality of key-point groups at least including a part of the plurality of key points; and a determining module 904, configured to determine a target human behavior based on key points in the plurality of key-point groups.

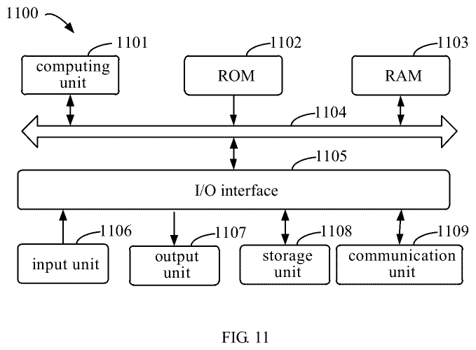

In some embodiments of the disclosure, as illustrated in FIG. 10, FIG. 10 is a block diagram according to a fifth embodiment of the disclosure. An apparatus 100 for detecting a human behavior includes: an obtaining module 1001, a recognizing module 1002, a grouping module 1003, and a determining module 1004. The determining module 1004 includes: a first determining sub-module 10041, configured to determine a target body region to which the key-point group belong based on key points in the key-point group; and a second determining sub-module 10042, configured to determine the target human behavior based on a body region category to which the target body region belongs.

In some embodiments of the disclosure, as illustrated in FIG. 10, the apparatus also includes: a detecting module 1005, configured to obtain a plurality of detection boxes by body detection on the image. The plurality of detection boxes respectively correspond to a plurality of body regions. The plurality of body regions respectively corresponding a plurality of candidate region categories.

In some embodiments of the disclosure, as illustrated in FIG. 10, the second determining sub-module 10042 is configured to: in response to the body region category matching any candidate region category, determine a target detection box corresponding to a matched candidate region category, the target detection box belonging to the plurality of detection boxes; calibrate a position of the target detection box based on a key-point group corresponding to the target body region; and determine the target human behavior based on the target detection box calibrated.

In some embodiments of the disclosure, as illustrated in FIG. 10, the second determining sub-module 10042 is configured to: in response to the body region category not matching any candidate region category, connect key points in a key-point group corresponding to the target body region to obtain a plurality of key-point connections; and determine the target human behavior based on the plurality of key-point connections.

In some embodiments of the disclosure, as illustrated in FIG. 10, the second determining sub-module 10042 is configured to: based on body structural characteristics, connect the key points in the key-point group from bottom to top using a greedy analytic algorithm.

It should be understood that, the apparatus 100 for detecting the human behavior in FIG. 10 in some embodiments of the disclosure may have a same function and structure as the apparatus 90 for detecting the human behavior in the above embodiments. The obtaining modules 901 and 1001, the recognizing modules 902 and 1002, the grouping modules 903 and 1003, and the determining modules 904 and 1004 may also have same functions and structures respectively.

It should be noted that, the above description for the method for detecting the human behavior may also be applicable to the apparatus for detecting the human behavior according to embodiments of the disclosure, which is not elaborated herein.

With embodiments of the disclosure, the image to be detected is obtained. The plurality of key points and the plurality of pieces of position information respectively corresponding to the plurality of key points are obtained by the key-point recognition on the image to be detected. The plurality of key points are grouped based on the plurality of pieces of position information to obtain the plurality of key-point groups. The plurality of key-point groups at least include the part of the plurality of key points. The target human behavior is determined based on the key points in the plurality of key-point groups. In this way, the accuracy and the efficiency of detection and recognition for the human behavior in the security patrol scene may be improved, thereby effectively satisfying the real-time requirements of detection and recognition in the security patrol scene.

According to embodiments of the disclosure, the disclosure also provides an electronic device, a readable storage medium, and a computer program product.

FIG. 11 is a block diagram illustrating an electronic device for implementing a method for detecting a human behavior according to embodiments of the disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, a smart phone, a wearable device and other similar computing device. The components, connections and relationships of the components, and functions of the components illustrated herein are merely examples, and are not intended to limit the implementation of the disclosure described and/or claimed herein.

As illustrated in FIG. 11, the device 1100 includes a computing unit 1101. The computing unit 1101 may perform various appropriate actions and processes based on a computer program stored in a read only memory (ROM) 1102 or loaded from a storage unit 1108 into a random access memory (RAM) 1103. In the RAM 1103, various programs and data required for the operation of the device 1100 may also be stored. The computing unit 1101, the ROM 1102, and the RAM 1103 are connected to each other via a bus 1104. An input/output (I/O) interface 1105 is also connected to the bus 1104.

Multiple components in the device 1100 are connected to the I/O interface 1105. The multiple components include an input unit 1106, such as a keyboard, and a mouse; an output unit 1107, such as various types of displays and speakers; a storage unit 1108, such as a magnetic disk, and an optical disk; and a communication unit 1109, such as a network card, a modem, and a wireless communication transceiver. The communication unit 1109 allows the device 1100 to exchange information/data with other devices via a computer network such as the Internet and/or various telecommunication networks.

The computing unit 1101 may be various general-purpose and/or special-purpose processing components with processing and computing capabilities. Some examples of the computing unit 1101 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 1101 performs various methods and processes described above, such as the method for detecting the human behavior.

For example, in some embodiments, the method for c detecting the human behavior may be implemented as a computer software program tangibly embodied in a machine-readable medium, such as the storage unit 1108. In some embodiments, a part or all of the computer program may be loaded and/or installed on the device 1100 via the ROM 1102 and/or the communication unit 1109. When the computer program is loaded into the RAM 1103 and executed by the computing unit 1101, one or more steps of the method for detecting the human behavior described above may be executed. Alternatively, in other embodiments, the computing unit 1101 may be configured to perform the method for detecting the human behavior by any other suitable means (for example, by means of firmware).

Various implementations of the systems and techniques described above herein may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), computer hardware, firmware, software, and/or a combination thereof. These various implementations may include being implemented in one or more computer programs. The one or more computer programs may be executed and/or interpreted on a programmable system including at least one programmable processor. The programmable processor may be a special purpose or general purpose programmable processor and receive data and instructions from and transmit data and instructions to a storage system, at least one input device, and at least one output device.

The program codes for implementing the method of detecting the human behavior of the disclosure may be written in any combination of one or more programming languages. These program codes may be provided to a processor or controller of a general purpose computer, a special purpose computer, or other programmable data processing apparatus, such that the program codes, when executed by the processor or controller, cause the functions/operations specified in the flow charts and/or block diagrams to be implemented. The program codes may be executed completely on the machine, partially on the machine, partially on the machine as an independent software package and partially on a remote machine or completely on a remote machine or server.

In the context of the disclosure, a machine-readable medium may be a tangible medium, which may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, an apparatus, or a device, or any suitable combination of the above. More specific examples of the machine-readable storage medium may include one or more wire-based electrical connections, a portable computer disk, a hard disk, a RAM, a ROM, an erasable programmable read-only memory (EPROM or flash memory), an optical fiber, a portable compact disk read-only memory (CD-ROM), an optical storage device, a magnetic storage device, or any suitable combination of the above.

To provide interaction with a user, the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), through which the user may provide the input to the computer. Other types of devices may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser through which the user may interact with embodiments of the system and technologies described herein), or a computing system including any combination of such background component, the middleware components and the front-end component. Components of the system may be connected to each other via digital data communication in any form or medium (such as, a communication network). Examples of the communication network include a local area network (LAN), a wide area networks (WAN), and the Internet.

The computer system may include a client and a server. The client and the server are generally remote from each other and generally interact via the communication network. A relationship between the client and the server is generated by computer programs operated on a corresponding computer and having a client-server relationship with each other. The server may be a cloud server, also known as a cloud computing server or a cloud host, which is a host product in a cloud computing service system, to solve difficult management and weak business scalability in conventional physical host and VPS (virtual private server) services. The server may also be a distributed system server or a server combined with a block chain.

It should be understood that, steps may be reordered, added or deleted by utilizing flows in the various forms illustrated above. For example, the steps described in the disclosure may be executed in parallel, sequentially or in different orders, so long as desired results of the technical solution disclosed in the disclosure may be achieved, there is no limitation here.

The above detailed implementations do not limit the protection scope of the disclosure. It should be understood by the skilled in the art that various modifications, combinations, sub-combinations and substitutions may be made based on design requirements and other factors. Any modification, equivalent substitution and improvement made within the principle of the disclosure shall be included in the protection scope of disclosure.

1. A method for detecting a human behavior, comprising:
obtaining an image to be detected;
obtaining a plurality of key points and a plurality of pieces of position information respectively corresponding to the plurality of key points by key-point recognition on the image to be detected;
grouping the plurality of key points based on the plurality of pieces of position information to obtain a plurality of key-point groups, the plurality of key-point groups at least comprising a part of the plurality of key points; and
determining a target human behavior based on key points in the plurality of key-point groups.

2. The method of claim 1, wherein determining the target human behavior based on the key points in the plurality of key point groups comprises:
determining a target body region to which the key-point group belong based on key points in the key-point group; and
determining the target human behavior based on a body region category to which the target body region belongs.

3. The method of claim 2, further comprising:
obtaining a plurality of detection boxes by body detection on the image to be detected, the plurality of detection boxes respectively corresponding to a plurality of body regions, and the plurality of body regions respectively corresponding a plurality of candidate region categories.

4. The method of claim 3, wherein determining the target human behavior based on the body region category to which the target body region belongs comprises:
in response to the body region category matching any candidate region category, determining a target detection box corresponding to a matched candidate region category, the target detection box belonging to the plurality of detection boxes;
calibrating a position of the target detection box based on a key-point group corresponding to the target body region; and
determining the target human behavior based on the target detection box calibrated.

5. The method of claim 4, wherein determining the target human behavior based on the body region category to which the target body region belongs comprises:
in response to the body region category not matching any candidate region category, connecting key points in a key-point group corresponding to the target body region to obtain a plurality of key-point connections; and
determining the target human behavior based on the plurality of key-point connections.

6. The method of claim 5, wherein connecting the key points in the key-point group corresponding to the target body region to obtain the plurality of key-point connections comprises:
based on body structural characteristics, connecting the key points in the key-point group from bottom to top using a greedy analytic algorithm.

7.-12. (canceled)

13. An electronic device, comprising:
a processor; and
a memory, communicatively coupled to the processor,
wherein the memory is configured to store instructions executable by the processor, and the processor is configured to:
obtain an image to be detected;
obtain a plurality of key points and a plurality of pieces of position information respectively corresponding to the plurality of key points by key-point recognition on the image to be detected;
group the plurality of key points based on the plurality of pieces of position information to obtain a plurality of key-point groups, the plurality of key-point groups at least comprising a part of the plurality of key points; and
determine a target human behavior based on key points in the plurality of key-point groups.

14. A non-transitory computer-readable storage medium having computer instructions stored thereon, wherein the computer instructions are configured to cause a computer to execute a method for detecting a human behavior, the method comprising:
obtaining an image to be detected;
obtaining a plurality of key points and a plurality of pieces of position information respectively corresponding to the plurality of key points by key-point recognition on the image to be detected;
grouping the plurality of key points based on the plurality of pieces of position information to obtain a plurality of key-point groups, the plurality of key-point groups at least comprising a part of the plurality of key points; and
determining a target human behavior based on key points in the plurality of key-point groups.

15. (canceled)

16. The device of claim 13, wherein the processor is configured to:
determine a target body region to which the key-point group belong based on key points in the key-point group; and
determine the target human behavior based on a body region category to which the target body region belongs.

17. The device of claim 16, wherein the processor is configured to:
obtain a plurality of detection boxes by body detection on the image to be detected, the plurality of detection boxes respectively corresponding to a plurality of body regions, and the plurality of body regions respectively corresponding a plurality of candidate region categories.

18. The device of claim 17, wherein the processor is configured to:
in response to the body region category matching any candidate region category, determine a target detection box corresponding to a matched candidate region category, the target detection box belonging to the plurality of detection boxes;
calibrate a position of the target detection box based on a key-point group corresponding to the target body region; and
determine the target human behavior based on the target detection box calibrated.

19. The device of claim 18, wherein the processor is configured to:
in response to the body region category not matching any candidate region category, connect key points in a key-point group corresponding to the target body region to obtain a plurality of key-point connections; and
determine the target human behavior based on the plurality of key-point connections.

20. The device of claim 19, wherein the processor is configured to:
based on body structural characteristics, connect the key points in the key-point group from bottom to top using a greedy analytic algorithm.

21. The non-transitory computer-readable storage medium of claim 14, wherein determining the target human behavior based on the key points in the plurality of key point groups comprises:
determining a target body region to which the key-point group belong based on key points in the key-point group; and
determining the target human behavior based on a body region category to which the target body region belongs.

22. The non-transitory computer-readable storage medium of claim 21, wherein the method further comprises:
obtaining a plurality of detection boxes by body detection on the image to be detected, the plurality of detection boxes respectively corresponding to a plurality of body regions, and the plurality of body regions respectively corresponding a plurality of candidate region categories.

23. The non-transitory computer-readable storage medium of claim 22, wherein determining the target human behavior based on the body region category to which the target body region belongs comprises:
in response to the body region category matching any candidate region category, determining a target detection box corresponding to a matched candidate region category, the target detection box belonging to the plurality of detection boxes;
calibrating a position of the target detection box based on a key-point group corresponding to the target body region; and
determining the target human behavior based on the target detection box calibrated.

24. The non-transitory computer-readable storage medium of claim 23, wherein determining the target human behavior based on the body region category to which the target body region belongs comprises:
in response to the body region category not matching any candidate region category, connecting key points in a key-point group corresponding to the target body region to obtain a plurality of key-point connections; and
determining the target human behavior based on the plurality of key-point connections.

25. The non-transitory computer-readable storage medium of claim 24, wherein connecting the key points in the key-point group corresponding to the target body region to obtain the plurality of key-point connections comprises:
based on body structural characteristics, connecting the key points in the key-point group from bottom to top using a greedy analytic algorithm.
